(19) United States
(12) Patent Application Publication
(10) Pub. No.: US 2026/0241838 A1
(43) Pub. Date: Aug. 20, 2026

(54) ADJUSTING DEVICE FOR A VEHICLE SEAT

(71) Applicant: Brose Fahrzeugteile SE & Co. Kommanditgesellschaft, Coburg, Coburg (DE)

(72) Inventor: Waldemar SCHRÖDER, Ahorn (DE)

(21) Appl. No.: 19/164,440

(22) PCT Filed: Mar. 12, 2024
(86) PCT No.: PCT/EP2024/056465

§ 371 Date: Sep. 11, 2025

(30) Foreign Application Priority Data
Mar. 14, 2023 (DE) 10 2023 202 289.3

(51) Int. Cl. B60N 2/06

(52) U.S. Cl. CPC B60N 2/067

(57) ABSTRACT

An adjusting device for a vehicle seat, comprising: a rail system which extends in a longitudinal direction and has a first rail and a second rail; and a spindle drive having a spindle and a spindle-nut unit. The spindle-nut unit has a cage having an insert which is received therein and which forms a spindle nut. The cage has a plurality of side walls which extend in the longitudinal direction and by means of which the cage encloses the insert, wherein at least one of the side walls engages with the insert in such a way that a form-fit acting in the longitudinal direction is formed between the at least one side wall and the insert. A crash-resistant connection is established thereby.

The invention relates to an adjusting device for a vehicle seat for longitudinally adjusting said seat, having the features of the preamble of claim 1.

Such an adjusting device has a rail system that extends in a longitudinal direction and has a first and a second rail as well as a spindle drive. The spindle drive comprises a spindle and a spindle-nut unit. The spindle-nut unit has a holder, which is designed in particular as a bent sheet metal part, and an insert that is received therein and forms a spindle nut which cooperates with the spindle to provide longitudinal adjustment. The spindle-nut unit is fastened to the first rail via the holder.

Such spindle drives must be designed to absorb forces acting in the longitudinal direction and, in particular, to be crash-resistant so that the forces acting during a crash can be reliably absorbed.

Such an adjusting device can be found, for example, in DE 10 2020 108 920 A1. The holder of this adjusting device is a sheet metal strip bent in the shape of a U, having two opposite sheet metal tabs oriented transversely to the longitudinal direction, through which the spindle is passed. These tabs, which are oriented transversely to the longitudinal direction, can absorb the forces acting in the longitudinal direction.

US 2009/0243326 A1 discloses a further adjusting device in which the holder is designed as a solid U-shaped component, which also has two opposite walls transverse to the longitudinal direction, through which the spindle is passed.

As a result of the spindle being passed through the tabs or walls, these are weakened so that the suitability of the holders is limited in terms of crash-resistance or special precautions must be taken to ensure sufficient crash safety. This leads, for example, to high material usage and/or high costs.

Proceeding therefrom, the object addressed by the invention is that of specifying an electric adjusting device for longitudinally adjusting a vehicle seat, in which reliable crash safety is achieved with a cost-effective structural design.

The object is achieved according to the invention by an electric adjusting device for a vehicle seat for longitudinally adjusting said seat, having the features of claim 1.

The adjusting device has a rail system that extends in a longitudinal direction and has a first rail, hereinafter referred to as the bottom rail, and a second rail, hereinafter referred to as the top rail. Furthermore, the adjusting device has a spindle drive which comprises a spindle and a spindle-nut unit. The spindle-nut unit has a cage and an insert received therein, which forms a spindle nut that interacts with the spindle. The spindle-nut unit is fastened in a crash-resistant manner to the first rail by means of the cage, usually by means of a screw fastening.

The cage is designed in particular as a metal cage. It has a plurality of side walls extending in the longitudinal direction, in particular specifically two lateral side walls, an upper side wall and a lower side wall. Furthermore, the cage has two opposite end faces when viewed in the longitudinal direction. The cage encloses the insert in the circumferential direction, which is oriented transversely to the longitudinal direction by means of the side walls. At least one of these side walls and in particular at least one lateral side wall engages with the insert in such a way that a form-fit acting in the longitudinal direction is formed between the side wall and the insert. The engagement between the insert and the at least one side wall of the cage enables high, particularly crash-resistant, force transmission between the insert and the cage.

Thus, a form-fit acting in the longitudinal direction is formed between the insert and the cage by means of at least one engagement element on the at least one side wall and at least one corresponding engagement element on the insert. These engagement elements are each extensions or formations, preferably on the insert, projecting transversely to the longitudinal direction and corresponding recesses or through-holes extending transversely to the longitudinal direction, which are preferably formed on the at least one side wall.

The particular advantage of this design can be considered that of the force being transmitted via the side walls oriented in parallel with the longitudinal direction. Therefore, structures oriented in the transverse direction through which the spindle has to be passed and which are therefore weakened by the spindle are not necessary for transmitting force.

In a preferred embodiment, a plurality of side walls and in particular the two lateral side walls engage with the insert. On the one hand, this achieves a symmetrical introduction of force. In addition, the force is distributed across at least two side walls unlike in conventional variants where only one transverse wall has to absorb all the forces.

In an expedient embodiment, the at least one side wall and the insert each have a plurality of complementary engagement elements, specifically recesses/through-holes and formations/extensions, which each interlock with one another. Complementary engagement elements are understood here to mean that they are designed to be suitable for transmitting force in the longitudinal direction. Preferably, these fit together perfectly—at least when viewed in the longitudinal direction. Preferably, all the side walls that engage with the insert each have engagement elements. Preferably, the side walls have the recesses and the insert has the formations. By arranging a plurality of engagement elements on each side wall, particularly favorable force introduction is achieved.

In a preferred embodiment, the engagement elements on the at least one side wall have different designs from one another. Correspondingly, the engagement elements on the insert also have different designs. This also optimizes force transmission.

Preferably, the at least one side wall has an open edge in one portion, comprising an edge contour via which the engagement is created. An open edge is understood here to mean a free end of the side wall (in a direction transverse to the longitudinal direction, in particular in the vertical direction). The side wall is therefore not connected to an adjacent side wall over a certain length in this portion. The insert engages with this edge contour from the opposite side and has formations that also form a complementary edge contour so that the interlocking edge contours create the engagement.

In particular, by means of the edge contour, a plurality of lugs and recesses therebetween are formed on the cage. The recesses are therefore limited by the edge contour and are open on one side. The overall edge contour is preferably wave-shaped or step-shaped. A wave trough/step bottom forms a recess and a wave crest/step tip forms a lug.

On the whole, the at least one side wall is therefore provided with a wave-shaped or step-shaped edge contour in a portion that is also referred to as the engagement portion. On the whole, this forms teeth between each side wall of the cage and a corresponding side wall of the insert.

In a preferred embodiment, the recesses, which are designed in the manner of incisions, end at different heights when viewed in the vertical direction. The same preferably also applies to the lugs. An edge portion of one recess or lug which delimits the edge contour in the vertical direction each time is therefore arranged at a different height than the corresponding edge portion of another recess/lug.

Alternatively or additionally, the recesses, which are designed in the manner of incisions, have different heights when viewed in the vertical direction. The same preferably also applies to the lugs. This also serves to optimize force transmission.

The cage is preferably designed as a bent sheet metal cage. Overall, the cage is preferably designed as a stamped and bent part, which can be manufactured easily and cost-effectively.

In a preferred development, the two end faces of the cage that are opposite one another in the longitudinal direction are open. This means that there are no wall regions on the end faces that extend in the transverse or vertical direction. Therefore, the formation of the cage in particular does not require any bending in a transverse direction to form a transverse wall perpendicular to the longitudinal direction. The cage therefore preferably does not have any wall regions or wall surfaces oriented transversely to the longitudinal direction. The edges of the side walls by means of which the engagement is created are not wall regions or wall surfaces that extend in the transverse direction.

Overall, in a preferred embodiment, a form-fit between the cage and the insert is formed exclusively by means of the side walls. In particular, these do not have any wall regions that protrude in the transverse direction.

Conveniently, the lower side wall of the cage is interrupted and forms an opening, which is designed in particular as an insertion opening into which the insert can be introduced into the cage from below. The opening extends over the entire width of the lower side wall. Preferably, the insert simply has a length that corresponds at most to the length of the opening in the longitudinal direction. Preferably, the length of the opening corresponds to the length of the insert in the longitudinal direction.

In order to fasten the cage to the first rail, the cage preferably has fastening tabs on the lower side wall. In particular, the lower side wall forms two fastening tabs that are opposite one another in the longitudinal direction. The previously mentioned opening is formed therebetween. The fastening tabs are used for fastening the cage to the first rail and usually lie flat on this first rail. For example, they have fastening holes, especially threaded holes for a screw fastening.

In an expedient embodiment, the two rails generally enclose a space in which the cage is perfectly received, at least in the transverse direction, except for the necessary degree of play. For this purpose, the cage preferably rests with its lower side wall on the first rail. With its two lateral side walls it abuts the second rail except for the degree of play mentioned. The two rails usually interlock in a form-fitting manner, with their edges being suitably shaped and engaging with one another. On the whole, the cage is inserted precisely into the space between the two rails, except for the degree of play specifically necessary for relative movement. At the same time, the insert fits perfectly into the cage. This results in good overall stability.

One embodiment of the invention will be explained in more detail below with reference to the drawings. In the figures,

FIG. 1 shows a perspective view of a detail of an electric adjusting device for longitudinally adjusting a vehicle seat, comprising an electric spindle drive,

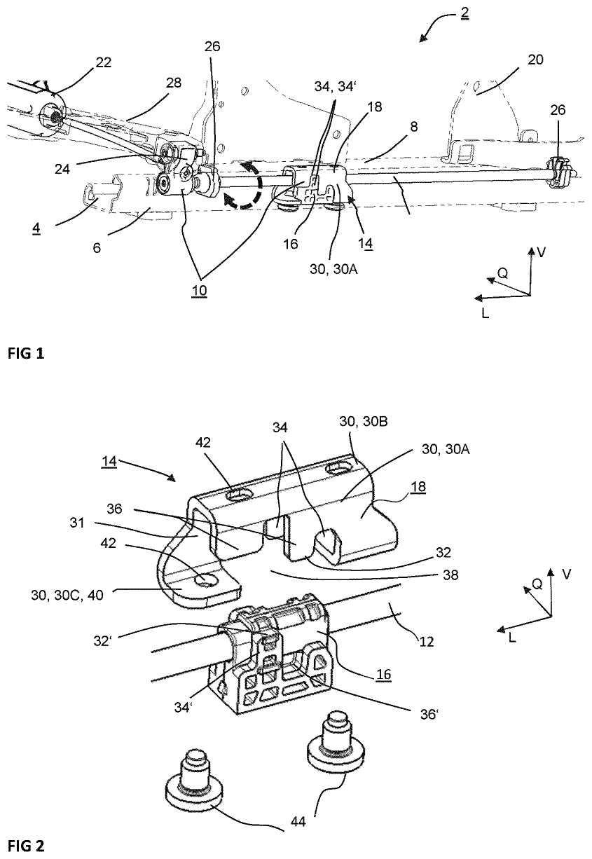

FIG. 2 shows an exploded view of a spindle-nut unit with the spindle passed therethrough, and

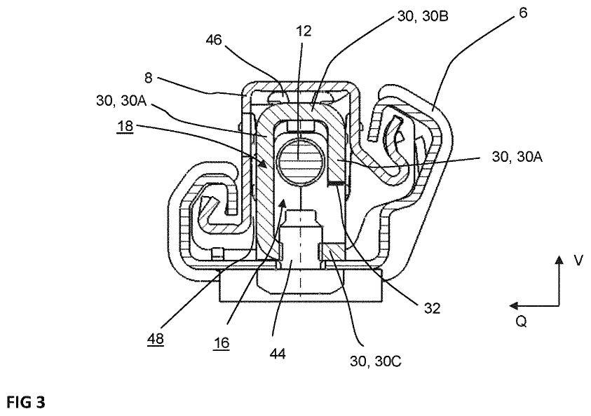

FIG. 3 shows a cross-sectional view through a rail system comprising a spindle-nut unit and with the spindle passed therethrough.

An adjusting device 2 shown in FIG. 1 serves for the longitudinal adjustment of a vehicle seat of a vehicle, in particular a road vehicle, especially a passenger car. The adjusting device 2 usually has two spaced-apart rail systems 4, each extending in the longitudinal direction L. In FIG. 1, only one of the rail systems 4 is shown. Each rail system 4 has a first rail designed as a bottom rail 6 and a second rail designed as a top rail 8. In order to longitudinally adjust the vehicle seat, the adjusting device 2 further has an electric spindle drive 10, which has a spindle 12 extending within the rail system 4 and a spindle-nut unit 14 that is also arranged within the rail system 4. This in turn has an insert 16 forming a spindle nut and a cage 18 that surrounds said insert.

In the embodiment, the spindle-nut unit 14 is rigidly connected to the bottom rail 6 via the cage 18. For longitudinal adjustment, the spindle 12 is rotated about a spindle axis by an electric motor drive. Through the interaction with the spindle nut formed by the insert 16, the rotary movement is converted into a longitudinal movement, which is transmitted to the top rail 8. A vehicle seat (not depicted in detail here) is fastened thereto via flanges 20.

For the electric motor drive, in the embodiment an electric motor 22 is connected via an output shaft, which is designed in particular as a flexible shaft, to a gear 24 which is coupled to the spindle 12. The spindle 12 is rotatably mounted in bearings 26. The electric motor 22 is accommodated in a carrier 28, which is made in particular of plastics and is usually attached to a front side of the vehicle seat between the—usually two—opposite rail systems 4. The electric motor 22, the output shaft and the gear 24 together with the carrier 28 form a motor-gear unit which is rigidly connected to the upper rail 8 and therefore moves therewith during longitudinal adjustment.

The spindle-nut unit 14 and thus also the cage 18 each extend in the longitudinal direction L (oriented toward the front of the vehicle), a transverse direction Q oriented perpendicularly thereto and a vertical direction V oriented perpendicularly to the longitudinal direction L and the transverse direction Q. The vertical direction V extends upward, i.e., from the bottom rail 6 toward the top rail 8 or in the direction of the vehicle seat.

On the whole, the spindle drive 10 must be designed to be crash-resistant. Particularly critical here is the application of force in or counter to the longitudinal direction L, which must be reliably transmitted via the spindle 12 to the insert 16 and via the cage 18 and the bottom rail 6 to the supporting body.

For this necessary force transmission, the cage 18 and the insert 16 are specially designed and in particular engage with one another. Essential for this are side walls 30 of the cage 18, which each extend in the longitudinal direction L and with which the insert 16 is enclosed in a circumferential direction transversely to the longitudinal direction L.

The engagement creates a form-fitting connection that acts in or counter to the longitudinal direction L. It should be emphasized that the engagement creates teeth between at least some of the side walls 30 of the cage 18 and the insert 16. The cage 18 preferably has no transverse walls at its end faces 31 that are opposite one another in the longitudinal direction, and is therefore open at these opposite end faces 31. The form-fit and thus the transmission of force are therefore preferably created exclusively via the side walls 30.

The structure of the spindle-nut unit 14 and its arrangement within the rail system 4 is shown in particular in FIG. 2 as well as FIG. 3:

The insert 16 is preferably designed as a plastics component. It has a thread in the interior thereof, which interacts with the thread of the spindle 12. The insert 16 therefore forms a spindle nut and the spindle 12 is passed through the insert 16.

The cage 18 is preferably designed as a sheet metal cage and in particular as a stamped and bent part. The cage 18 has the above-mentioned side walls 30, namely two opposite lateral side walls 30A, an upper side wall 30B and a lower side wall 30C. The two opposite lateral side walls 30A preferably each extend within a vertical plane which is spanned by the vertical direction V and the longitudinal direction L. The upper side wall 30B and the lower side wall 30C preferably each extend within a horizontal plane which is spanned by the transverse direction Q and the longitudinal direction L.

As can be seen in particular from FIG. 2, each lateral side wall 30A ends—when viewed in a defined longitudinal portion and counter to the vertical direction V—at a free edge, i.e., is not connected to the lower side wall 30C via the longitudinal portion. This free edge forms a special edge contour 32, by means of which recesses 34 and lugs 36 are formed on each lateral side wall 30A. The lugs 36 are formed by portions of the lateral side walls 30A, which protrude freely in the opposite direction to the vertical direction V. The different recesses 34 and lugs 36 form engagement elements which interact with corresponding engagement elements on the insert 16.

The insert 16 has a corresponding edge contour 32′, by means of which a plurality of formations 34′ are formed that complement the recesses 34, which formations thus form corresponding and complementary engagement elements with respect to the recesses 34 and engage therewith in a form-fitting manner.

Corresponding to the lugs 36 on the cage 18, the insert 16 has indentations 36′.

Overall, the insert 16 is characterized in that it is widened in the transverse direction Q in the lower sub-region oriented toward the lower rail 6, preferably by exactly twice the wall thickness of the cage 18. In a preferred embodiment, in the inserted state, the complementary engagement elements 34, 34′ are aligned with one another on the lateral outer sides of the spindle-nut unit 14.

The recesses 34 in the cage 18 have different designs from one another. The same also applies to the lugs 36.

In particular, the recesses 34 are limited toward the top by an edge portion when viewed in the vertical direction 4. The edge portions of the various recesses 34 are arranged at different heights when viewed in the vertical direction V, i.e., the upper boundaries of the recesses 34 are offset from one another.

Alternatively or additionally, the recesses 34 have a different height in the vertical direction V.

Alternatively or additionally, the recesses 34 have a different width in the longitudinal direction L.

Due to the complementary design of the insert 16, this correspondingly also applies to the complementary formations 34′ and indentations 36′ on the insert 16.

During assembly, the insert 16 is inserted from below into the interior of the cage 18 in the vertical direction V via an opening 38 formed in the lower side wall 30B. Due to the special edge contours 32, 32′, the cage 18 and the insert 16 automatically engage in the manner of teeth.

The lower side wall 30C is therefore interrupted by the opening 38. The lower side wall 30C is formed by two opposite fastening tabs 40, in each of which fastening holes 42 are made, in each of which a fastening element 44, for example a screw or a rivet, engages for fastening to the lower rail 6. In the case of a screw connection, the fastening holes 42 are designed, for example, as threaded holes and have an internal thread. When fastened, the fastening tabs 40 lie flat on the lower rail 6.

Overall, the insert 16 has a length in the longitudinal direction L which preferably corresponds exactly to the length of the opening 38. In the inserted state, the insert 16 is held in a form-fitting manner by edge portions of the fastening tabs 40. An appropriate height is therefore chosen for the insert 16. In particular, a lower side of the insert 16 is aligned with a lower side of the lower side wall 30C. Preferably, the insert 16 lies flat on the lower rail 6 in the mounted position.

In the embodiment, the upper side wall 30B also has fastening holes 42 to which fixing elements 46 engage in the assembled state. As can be seen in particular from FIG. 3, in a preferred embodiment these interact with the insert 16 and fix it in position.

As can be seen in particular from the cross-sectional view of FIG. 3, the cage 18 encloses the insert 16 by means of the side walls 30 so that the side walls 30, especially the lateral side walls 30A, thus lie flat against the corresponding wall portions of the insert 16 and form the desired engagement via the edge contour 32.

Furthermore, it can be seen that the lower rail 6 and the upper rail 8 each have specially shaped lateral edge contours which interlock so that the two rails 6, 8 interlock in the vertical direction V in a form-fitting manner. In the embodiment, a space 48 is formed between the two rails 6, 8, in which the spindle-nut unit 14 is received. In the transverse direction Q, the spindle-nut unit 14 preferably fits perfectly in this space 48, except for the necessary amount of play. The lateral side walls 30A are each arranged opposite to corresponding side walls of the upper rail 8 and preferably only have a tolerance gap with respect thereto in order to enable the required relative displacement between the upper rail 8 and the spindle-nut unit 14 fastened to the lower rail 6.

Overall, the spindle-nut unit 14 described here with the special design of the cage 18 and the insert 16 in which they engage/interlock with one another exclusively via the side walls 30 achieves a cost-effective and easy-to-manufacture construction which is designed to absorb high forces and thus ensures high crash safety.

List of reference numbers

| | | | |
|---|---|---|---|
| 2 | Adjusting device | L | Longitudinal direction |
| 4 | Rail system | Q | Transverse direction |
| 6 | Bottom rail | V | Vertical direction |
| 8 | Top rail | | |
| 10 | Spindle drive | | |
| 12 | Spindle | | |
| 14 | Spindle-nut unit | | |
| 16 | Insert | | |
| 18 | Cage | | |
| 20 | Flange | | |
| 22 | Electric motor | | |
| 24 | Gear unit | | |
| 26 | Bearing | | |
| 28 | Carrier | | |
| 30 | Side walls | | |
| 30A | Lateral side wall | | |
| 30B | Upper side wall | | |
| 30C | Lower side wall | | |
| 31 | End face | | |
| 32 | Edge contour of the cage | | |
| 32′ | Edge contour of the insert | | |
| 34 | Recess | | |
| 34′ | Formation | | |
| 36 | Lugs | | |
| 36′ | Indentation | | |
| 38 | Opening | | |
| 40 | Fastening tab | | |
| 42 | Fastening hole | | |
| 44 | Fastening element | | |
| 46 | Fixing elements | | |

| | |
|---|---|
| 48 | Space |

1. An adjusting device for a vehicle seat, having a rail system which extends in a longitudinal direction and has a first rail and a second rail, and a spindle drive which has a spindle and a spindle-nut unit, the spindle-nut unit having a holder and an insert which is received therein and which forms a spindle nut, the holder being fastened to the first rail, wherein the holder is designed as a cage which has a plurality of side walls extending in the longitudinal direction, in particular specifically two lateral side walls, an upper side wall and a lower side wall, the cage enclosing the insert by means of the side walls, and that at least one of the side walls engages with the insert in such a way that a form-fit acting in the longitudinal direction is formed between the at least one side wall and the insert.

2. The adjusting device according to claim 1, wherein a plurality of side walls in particular the two lateral side walls, engage with the insert.

3. The adjusting device according to claim 1, wherein the at least one side wall and the insert each have a plurality of complementary interlocking elements which each interlock with one another.

4. The adjusting device according to claim 3, wherein the interlocking elements on the at least one side wall have different designs from one another.

5. The adjusting device according to claim 1, wherein the at least one side wall has an open edge in one portion, which forms an edge contour via which the engagement is created.

6. The adjusting device according to claim 5, wherein the edge contour forms a plurality of recesses as interlocking elements as well as lugs located therebetween and the edge contour is in particular wave-shaped or step-shaped.

7. The adjusting device according to claim 6, wherein the recesses end at different heights when viewed in the vertical direction.

8. The adjusting device according to claim 6, wherein the recesses have different heights.

9. The adjusting device according to claim 1, wherein the cage is designed as a sheet metal bent cage.

10. The adjusting device according to claim 1, wherein the cage has two opposite end faces in the longitudinal direction which are open.

11. The adjusting device according to claim 1, wherein the cage and the insert are exclusively interlocked by means of the side walls.

12. The adjusting device according to claim 1, wherein the lower side wall of the cage is interrupted and has an opening into which the insert can be inserted into the cage from below.

13. The adjusting device according to claim 1, wherein fastening tabs are formed for fastening the lower side wall of the cage to the first rail.

14. The adjusting device according to claim 1, wherein the two rails enclose a space in which the cage is received so as to precisely fit in the transverse direction except for the necessary degree of play.
